(19) United States
(12) Patent Application Publication
(10) Pub. No.: US 2013/0093700 A1
(43) Pub. Date: Apr. 18, 2013

(54) TOUCH-CONTROL COMMUNICATION SYSTEM

(71) Applicants: Tung-Tsai LIAO, Hsinchu City (TW); Lih-Shang LO, Hsinchu County (TW)

(72) Inventors: Tung-Tsai LIAO, Hsinchu City (TW); Lih-Shang LO, Hsinchu County (TW)

(21) Appl. No.: 13/588,239

(22) Filed: Aug. 17, 2012

(30) Foreign Application Priority Data
Oct. 17, 2011 (TW) 100137547

(51) Int. Cl. G06F 3/041

(52) U.S. Cl. 345/173

(57) ABSTRACT

A touch-control communication system includes a touch panel, a controller, a plurality of conductive contacts, and a switch control unit. The touch panel has a surface for detecting a plurality of touch points. The controller is electrically connected to the touch panel for receiving data corresponding to the plurality of touch points detected on the touch panel. The conductive contacts are placed on the surface of the touch panel. The switch control unit is electrically connected to the plurality of conductive contacts. The switch control unit performs a switch operation to configure every two of the plurality of conductive contacts to be electrically connected or disconnected, such that the touch panel detects different numbers of touch points corresponding to the plurality of conductive contacts for indicating a plurality of data states, thereby sending the plurality of data states to the controller.

### CROSS REFERENCE TO RELATED APPLICATION

This application claims the benefits of the Taiwan Patent Application Serial Number 100137547, filed on Oct. 17, 2011, the subject matter of which is incorporated herein by reference.

### BACKGROUND OF THE INVENTION

1. Field of the Invention

The present invention relates to the technical field of touch panels and, more particularly, to a touch-control communication system.

2. Description of Related Art

Current consumer electronics are typically provided with a touchpad as one of the input devices. To meet with the requirements of light, thin, short, and small, a touchpad and a panel are combined into a touch panel for users to conveniently input data.

Upon the sensing principle, there are at least four types of touchpad available in the market now, which are resistive type, capacitive type, surface acoustic wave type, and optics type. The operation principle of touch panels is to sense a voltage, a current, an acoustic wave or an infrared when a finger or other medium touches on a touch screen, so as to detect the coordinates of touching points. For example, a resistive touch panel uses a voltage difference between the upper and lower electrodes to compute the position where a force is applied so as to detect the touching point, and a capacitive touch panel uses the current or the voltage originated from capacitance changes in a static electricity combination of transparent electrodes arranged in row and column with human body to detect the touching coordinate.

FIG. 1 is a schematic view of driving a prior capacitive touch panel which is an n×m touch panel 120, where n, m are each an integer greater than one. As shown in FIG. 1, a controller 110 sequentially applied a driving signal Vin into the conductor lines X1-Xn in one direction for coupling charges into the conductor lines Y1-Ym, in the other direction through mutual capacitance between the conductor lines X1-Xn and the conductor lines Y1-Ym. The controller 110 has m sensors (not shown) to measure the charges for further generating the voltage signals.

FIG. 2 is a schematic view illustrating the structure of the prior capacitive touch panel. As shown in FIGS. 1 and 2, the conductor lines X1-Xn and Y1-Ym are comprised of diamond sensing conductors 121-124, and the mutual capacitance 201-204 is generated between the diamond sensing conductors 121-124, which is not a physical capacitor but mutually induced by the diamond sensing conductors 121-124.

FIGS. 3 and 4 are schematic views illustrating a typical capacitive touch panel without and with a finger to be close to. As shown in FIG. 3, when there is no grounded conductor or finger that is close to the touch panel 120, the mutual capacitance C_{(x,y)} equals to Cm0. As shown in FIG. 4, when a grounded conductor or finger is close to the touch panel, the electrical power lines between the conductor lines X1-Xn and Y1-Ym are interfered and reduced to further affect on the values of the mutual capacitance (assumed to be Cm1 at contact). The sensors use a change of the mutual capacitance to measure the charges and further generate the voltage signals.

With reference again to FIGS. 1, 3, and 4 for illustrating that a finger is close to an area comprised of the sensing conductors 121-124 of the touch panel, when the controller 110 generates the driving signal Vin on the conductor line X2, at time T1, since there is no finger or grounded conductor at the intersection of the conductor lines X2 and Y1, the controller 110 can detect a high potential.

At time T2, a virtual grounded signal is detected because the finger or grounded conductor is at the intersection of the conductor lines X2 and Y2, and in this case the power lines at the intersection are reduced, such that the controller 110 can detect a low potential, i.e., the controller 110 can detect a touch point positioned at the intersection of the conductor lines X2 and Y2. It is noted that the finger or grounded conductor does not directly touch the conductor lines, and instead, touches the conductor lines via a cover of lens. Similarly, at time T3, there is no finger or grounded conductor at the intersection of the conductor lines X2 and Y1, and the controller 110 can detect a high potential. Accordingly, multiple touch points on the touch panel can be detected.

Owing to smart phones and tablet PCs are more and more popular, they are typically equipped with a multi-touch screen. In addition, a smart phone or tablet PC is always connected with the peripherals through the interfaces of USB, SD, Bluetooth, and the like. However, the handheld devices with a touch screen do not use the features of the touch screen for data transfer. Therefore, it is desirable to provide an improved touch-control communication system to mitigate and/or obviate such a problem.

### SUMMARY OF THE INVENTION

The object of the present invention is to provide a touch-control communication system, which makes use of a touch panel to transfer data.

To achieve the object, there is provided a touch-control communication system, which includes a touch panel, a controller, a plurality of conductive contacts, and a switch control unit. The touch panel has a surface for detecting a plurality of touch points. The controller is electrically connected to the touch panel for receiving data corresponding to the plurality of touch points detected on the touch panel. The conductive contacts are placed on the surface of the touch panel. The switch control unit is electrically connected to the plurality of conductive contacts. The switch control unit performs a switch operation to configure every two of the plurality of conductive contacts to be electrically connected or disconnected, such that the touch panel detects different numbers of touch points corresponding to the plurality of conductive contacts for indicating a plurality of data states, thereby sending the plurality of data states to the controller.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of driving a prior capacitive touch panel;

FIG. 2 is a schematic view illustrating the structure of the prior capacitive touch panel;

FIG. 3 is a schematic view illustrating a typical touch panel without a finger to be close to;

FIG. 4 is a schematic view illustrating a typical touch panel with a finger to be close to;

FIG. 5 is a schematic view of a touch-control communication system according to an embodiment of the present invention;

FIG. 6 is a schematic view illustrating data determined by a controller according to an embodiment of the present invention;

FIG. 7 is a schematic view of a touch-control communication system according to another embodiment of the present invention;

FIG. 8 is a schematic view illustrating data determined by a controller according to another embodiment of the present invention;

FIG. 9 is a schematic view of a touch-control communication system according to a further embodiment of the present invention;

FIG. 10 is a schematic view of a touch-control communication system according to another further embodiment of the invention; and

FIG. 11 is a flowchart of using a controller to determine data according to an embodiment of the present invention.

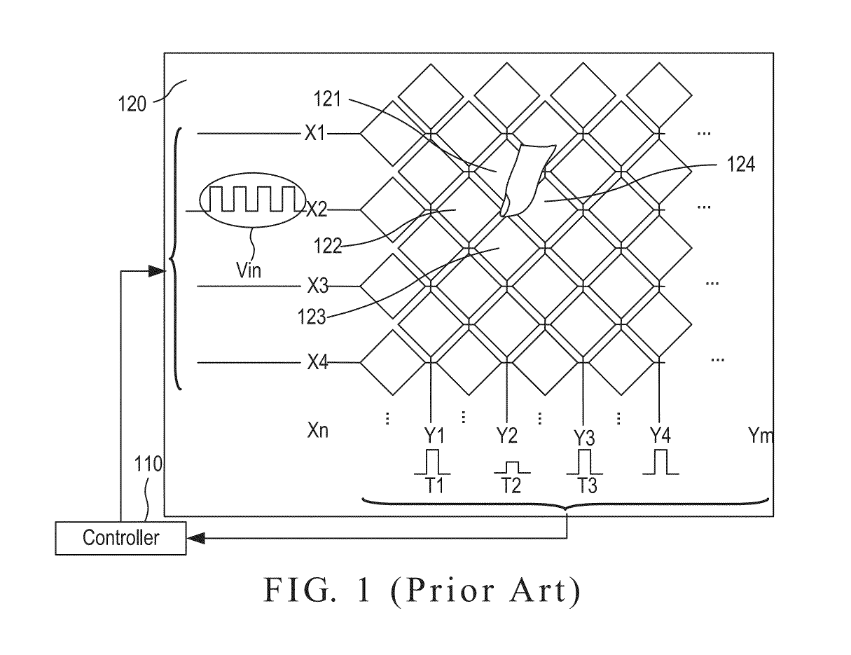

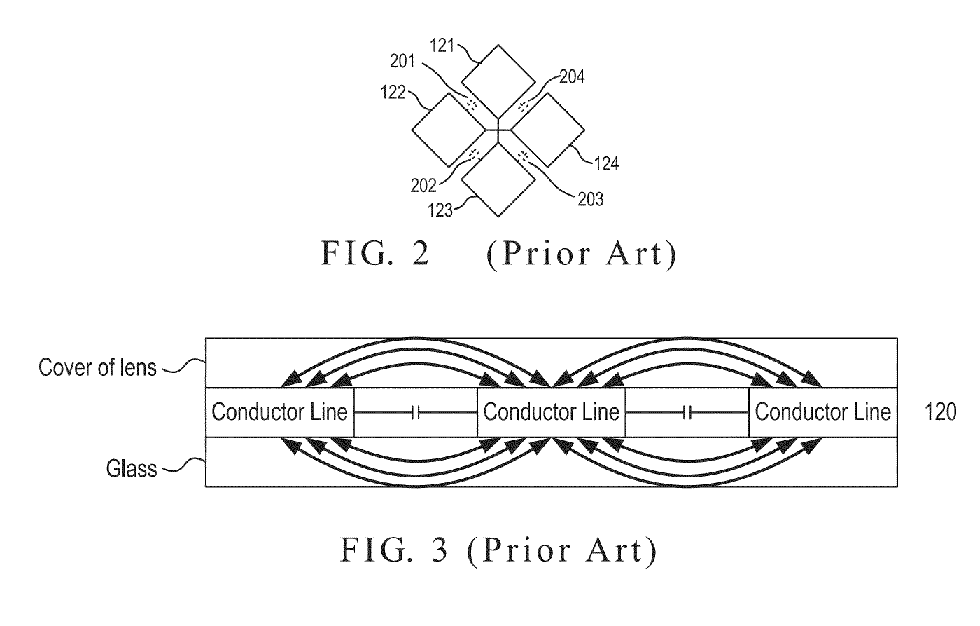

### DETAILED DESCRIPTION OF THE PREFERRED EMBODIMENT

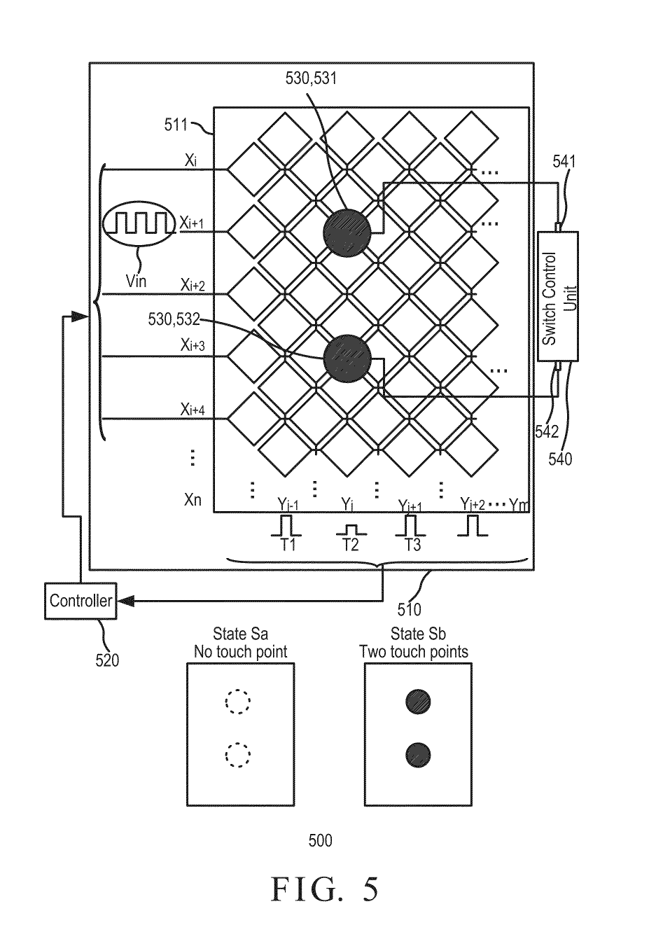

FIG. 5 is a schematic view of a touch-control communication system according to an embodiment of the present invention. In FIG. 5, the touch-control communication system 500 includes a touch panel 510, a controller 520, a plurality of conductive contacts 530, and a switch control unit 540.

The touch panel 510 has a surface 511 for detecting a plurality of touch points touched by the fingers or other objects of users. The controller 520 is electrically connected to the touch panel 510 for receiving data corresponding to the plurality of touch points detected on the touch panel.

The plurality of conductive contacts 530 are placed on the surface 511 of the touch panel 510. The switch control unit 540 is electrically connected to the plurality of conductive contacts 530 for configuring every two of the plurality of conductive contacts to be electrically connected or disconnected.

Since the switch control unit 540 configures every two of the plurality of conductive contacts 530 to be electrically connected or disconnected, the touch panel 510 can detect different numbers of touch points corresponding to the plurality of conductive contacts for indicating a plurality of data states, thereby sending the plurality of data states to the controller 520.

In this embodiment, as shown in FIG. 5, the plurality of conductive contacts 530 include two conductive contacts 531 and 532. The conductive contact 531 is placed at the intersection of the conductor lines Xᵢ₊₁ and Yⱼ, and the conductive contact 532 is placed at the intersection of the conductor lines Xᵢ₊₃ and Yⱼ. When the switch control unit 540 configures the two conductive contacts 531, 532 to be electrically disconnected, the touch panel 510 detects no touch point for indicating a first data state Sa. When the switch control unit 540 configures the two conductive contacts 531, 532 to be electrically connected, the touch panel 510 detects two touch points for indicating a second data state Sb.

When the two conductive contacts 531 and 532 are electrically disconnected, they are floating and thus the power lines at the intersection of the conductor lines Xᵢ₊₁ and Yⱼ on the touch panel 510 are not reduced.

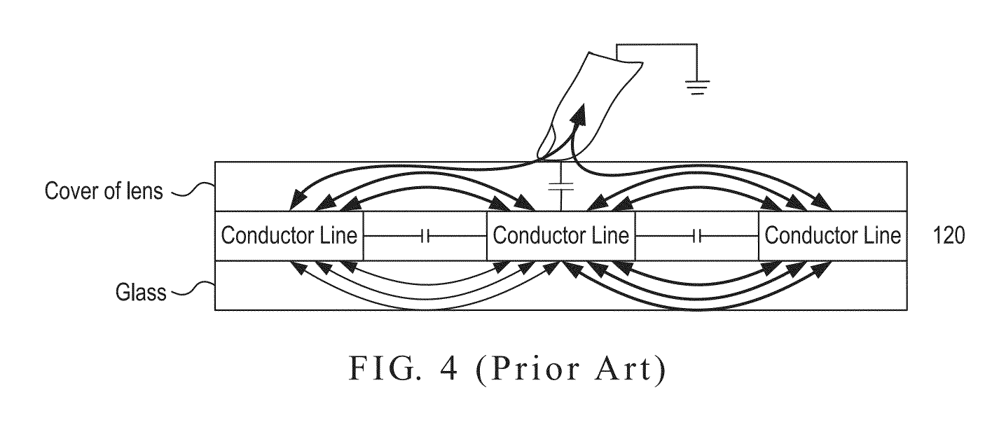

When the two conductive contacts 531 and 532 are electrically connected, the controller 520 generates a driving signal Vin on the conductor line Xᵢ₊₁, so that the conductor line Xᵢ₊₃ is at a low potential. In this case, as shown in FIG. 4, the conductive contact 532 is virtually grounded due to the conductor line Xᵢ₊₃. In addition, since the two conductive contacts 531 and 532 are electrically connected, the conductive contact 531 is also virtually grounded, so that the power lines at the intersection of the conductor lines Xᵢ₊₁ and Yⱼ on the touch panel 510 are greatly reduced. In this case, the controller 520 detects a low potential; i.e., the controller 520 detects a touch point which is positioned at the intersection of the conductor lines Xᵢ₊₁ and Yⱼ.

When the controller 520 generates a driving signal Vin on the conductor line Xᵢ₊₃, the conductor line Xᵢ₊₁ is at a low potential, so that the conductive contact 531 is virtually grounded due to Xᵢ₊₁. In addition, since the two conductive contacts 531 and 532 are electrically connected, the conductive contact 532 is also virtually grounded, so that the power lines at the intersection of the conductor lines Xᵢ₊₃ and Yⱼ on the touch panel 510 are reduced. In this case, the controller 520 detects a low potential; i.e., the controller 520 detects another touch point which is positioned at the intersection of the conductor lines Xᵢ₊₃ and Yⱼ.

The switch control unit 540 is preferably a micro control unit (MCU). The MCU has two general purpose input/output (GPIO) pins 541 and 542. The GPIO pins 541 and 542 are connected to the two conductive contacts 531 and 532 respectively. When the two GPIO pins 541 and 542 output a low potential, the switch control unit 540 is conducted, and the two conductive contacts 531 and 532 are electrically connected. When the two GPIO pins 541 and 542 do not output a low potential, the switch control unit 540 is not conducted, and the two conductive contacts 531 and 532 are electrically disconnected.

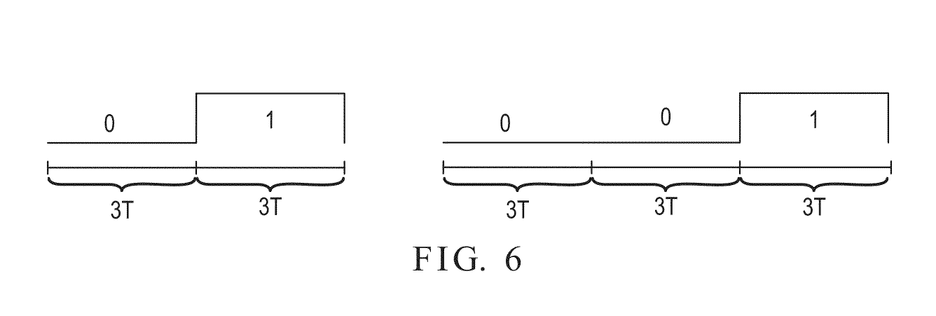

Accordingly, when the plurality of conductive contacts 530 include two conductive contacts 531, 532, the controller 520 can detect none or two touch points, wherein detection of no touch point indicates the first data state Sa, and detection of two touch points indicates the second data state Sb. FIG. 6 is a schematic view illustrating data determined by the controller 520 according to an embodiment of the present invention. When a duration time of the first data state Sa is over triple of the detection time (T) on the touch panel 510, the controller 520 determines a data state to be logic “0”. When a duration of the second data state Sb is over triple of the detection time (T) on the touch panel 510, the controller 520 determines a data state to be logic “1”. The controller 520 is based on the duration detected at the first data state Sa (no touch point) or the second data state Sb (two touch points) to determine the data structure. For example, when the duration of no touch point is detected to be between 2 T and 4 T and immediately followed that two touch points are detected, the controller 520 determines that a logic of “0” is detected. Furthermore, when the duration of no touch point is detected to be between 5 T and 7 T and immediately followed that two touch points are detected, the controller 520 determines that a logic of “00” is detected, and so on.

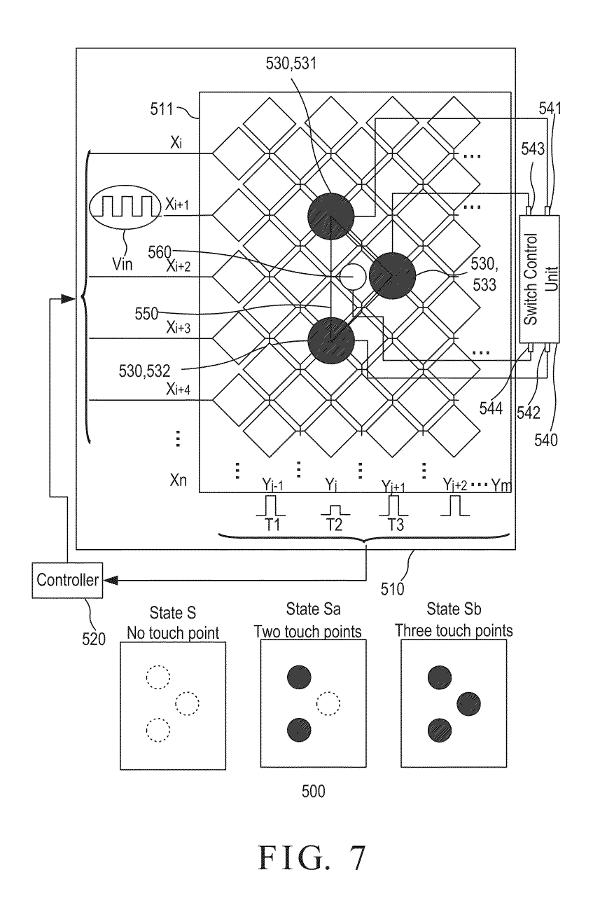

FIG. 7 is a schematic view of a touch-control communication system according to another embodiment of the present invention, which is similar to the first embodiment shown in FIG. 5, except that the plurality of conductive contacts 530 include three conductive contacts 531, 532, and 533. The touch panel 510 detects no touch point when the switch control unit 540 configures every two of the three conductive contacts 531-533 to be electrically disconnected, thereby indicating a start state S. The touch panel 510 detects two touch points when the switch control unit 540 configures only two of the three conductive contacts 531-533 to be electrically connected, thereby indicating a first data state Sa. The touch panel 510 detects three touch points when the switch control unit 540 configures the three conductive contacts 531-533 to be electrically connected to one another, thereby indicating a second data state Sb. The three conductive contacts 531-533 form a triangle 550, for example an equilateral triangle, on the surface 511 of the touch panel 510.

The switch control unit 540 is preferably a micro control unit (MCU). The MCU has three general purpose input/output (GPIO) pins 541 542, and 543 for connecting to the three conductive contacts 531, 532, and 533 respectively.

When the three GPIO pins 541, 542, and 543 are floating, every two of the three conductive contacts 531, 532, and 533 are electrically disconnected, so that the touch panel 510 detects no touch point. When two of the three GPIO pins 541, 542, and 543 output a low potential, only the two conductive contacts corresponding to the two GPIO pins at the low potential are electrically connected, so that the touch panel 510 detects two touch points. When the three GPIO pins 541, 542, and 543 output a low potential, the three conductive contacts 531, 532, and 533 corresponding to the three GPIO pins 541, 542, and 543 are electrically connected to one another, so the touch panel 510 detects three touch points.

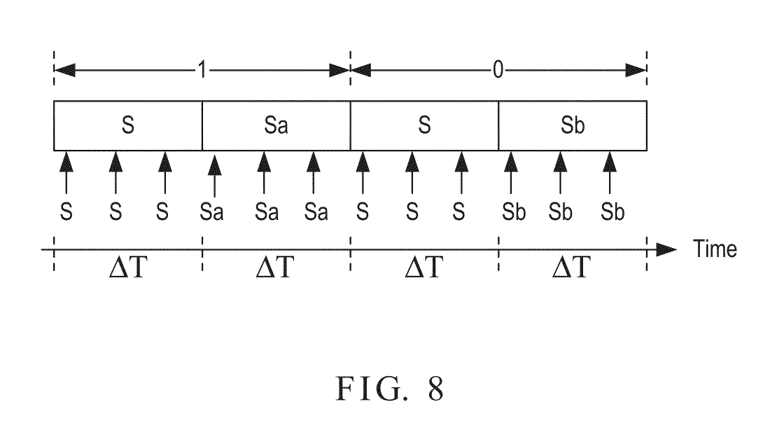

FIG. 8 is a schematic view illustrating data determined by the controller 520 according to another embodiment of the present invention. As show in FIG. 8, the controller 520 determines a data state to be logic “1” when the start state S and the second data state Sb are detected by the controller 520, and determines a data state to be logic “0” when the start state S and the first data state Sa are detected, where ΔT indicates a duration over twice of the detection time on the touch panel 510, and preferably ΔT is triple of the detection time on the touch panel 510. Namely, when the detection time on the touch panel 510 is 120 Hz, ΔT=(1/120 Hz)*3=25 ms.

With reference to FIG. 7 again, the touch-control communication system further includes a photosensor 560 connected to an input pin 544 of the switch control unit 540. The photosensor 560 is placed in the triangle 550 on the surface 511 of the touch panel 510. The controller 520 makes use of different brightness displayed on the surface 511 of the touch panel corresponding to the photosensor 560 to transfer data to the switch control unit 540. The controller 520 detects the positions of the three conductive contacts 531, 532, 533 for determining a position of the triangle 550. Since the touch panel 510 is generally placed on a display panel (not shown), the controller 520 can drive the display panel to generate different brightness at the position of the triangle 550, and the surface 511 of the touch panel can display the different brightness. In this case, the photosensor 560 can detect the different brightness on the surface 511 of the touch panel 510 for generating the corresponding data states, such as logics “0” and “1”, so that the controller 520 can transfer data to the switch control unit 540.

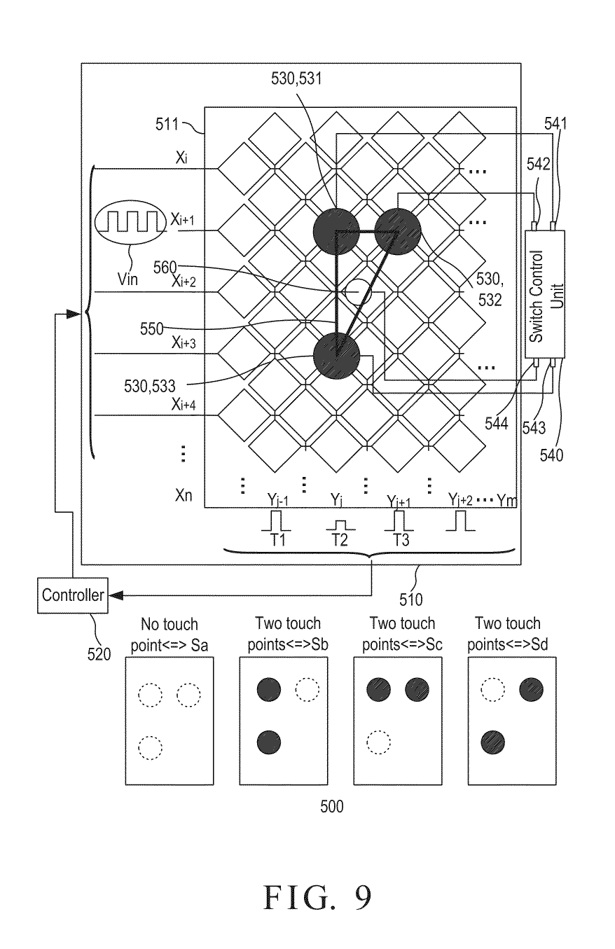

FIG. 9 is a schematic view of a touch-control communication system according to a further embodiment of the present invention, which is similar to the first embodiment shown in FIG. 5. The plurality of conductive contacts 530 include a first conductive contact 531, a second conductive contact 532, and a third conductive contact 533. The first conductive contact 531, the second conductive contact 532, and the third conductive contact 533 are placed on the surface 511 of the touch panel 510 for forming a triangle 550, for example a non-equilateral triangle. The touch panel 510 detects no touch point when the switch control unit 540 configures every two of the first, the second, and the third conductive contacts 531-533 to be electrically disconnected, thereby indicating a first data state Sa. The touch panel 510 can detect two touch points corresponding to the positions of the first and the third conductive contacts 531 and 533 when the switch control unit 540 configures the first conductive contact 531 and the third conductive contact 533 to be electrically connected, thereby indicating a second data state Sb. The touch panel 510 can detect two touch points corresponding to the positions of the first and the second conductive contacts 531 and 532 when the switch control unit 540 configures the first conductive contact 531 and the second conductive contact 532 to be electrically connected, thereby indicating a third data state Sc. The touch panel 510 can detect two touch points corresponding to the positions of the second and the third conductive contacts 532 and 533 when the switch control unit 540 configures the second conductive contact 532 and the third conductive contact 533 to be electrically connected, thereby indicating a fourth data state Sd.

When the touch panel 510 detects the first data state Sa, the controller 520 determines a data state to be logic “00”. When the touch panel 510 detects the second data state Sb, the controller 520 determines a data state to be logic “01”. When the touch panel 510 detects the third data state Sc, the controller 520 determines a data state to be logic “10”. When the touch panel 510 detects the fourth data state Sd, the controller 520 determines a data state to be logic “11”.

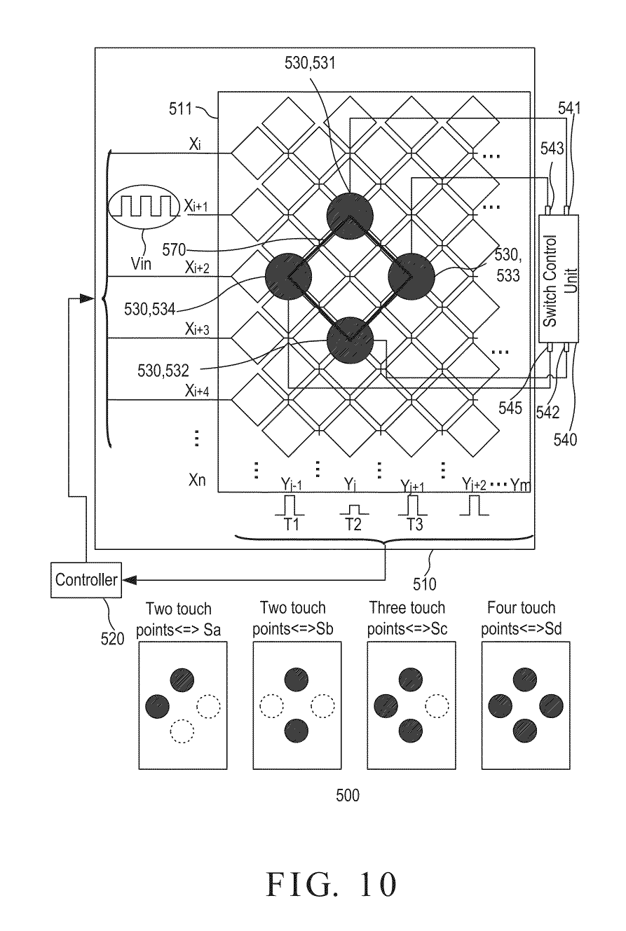

FIG. 10 is a schematic view of a touch-control communication system according to another further embodiment of the present invention, which is similar to the first embodiment shown in FIG. 5, except that the plurality of conductive contacts 530 include a first conductive contact 531, a second conductive contact 532, a third conductive contact 533, and a fourth conductive contact 534. The first conductive contact 531, the second conductive contact 532, the third conductive contact 533, and the fourth conductive contact 534 are placed on the surface 511 of the touch panel 510 for forming a diamond 570. The first and the second conductive contacts 531 and 532 are two opposite vertices of the diamond 570, and the first and the fourth conductive contacts 531 and 534 are two adjacent vertices of the diamond 570. When the switch control unit 540 configures the first conductive contact 531 and the fourth conductive contact 534 to be electrically connected, the touch panel 510 can detect two touch points corresponding to the positions of the first conductive contact 531 and the fourth conductive contact 534, thereby indicating a first data state Sa. When the switch control unit 540 configures the first conductive contact 531 and the second conductive contact 532 to be electrically connected, the touch panel 510 can detect two touch points corresponding to the positions of the first conductive contact 531 and the second conductive contact 532, thereby indicating a second data state Sb. When the switch control unit 540 configures the first and fourth conductive contacts 531, 534 to be electrically connected and the first and second conductive contacts 531, 532 to be electrically connected, the touch panel 510 can detect three touch points corresponding to the positions of the first conductive contact 531, the second conductive contact 532, and the fourth conductive contact 534, thereby indicating a third data state Sc. When the switch control unit 540 configures the first and fourth conductive contacts 531, 534 to be electrically connected, the first and second conductive contacts 531, 532 to be electrically connected, and the first and third conductive contacts 531, 533 to be electrically connected, the touch panel 510 can detect four touch points corresponding to the positions of the first conductive contact 531, the second conductive contact 532, the third conductive contact 533, and the fourth conductive contact 534, thereby indicating a fourth data state Sd.

When the touch panel 510 detects the first data state Sa, the controller 520 determines a data state to be logic “00”. When the touch panel 510 detects the second data state Sb, the controller 520 determines a data state to be logic “01”. When the touch panel 510 detects the third data state Sc, the controller 520 determines a data state to be logic “10”. When the touch panel 510 detects the fourth data state Sd, the controller 520 determines a data state to be logic “11”.

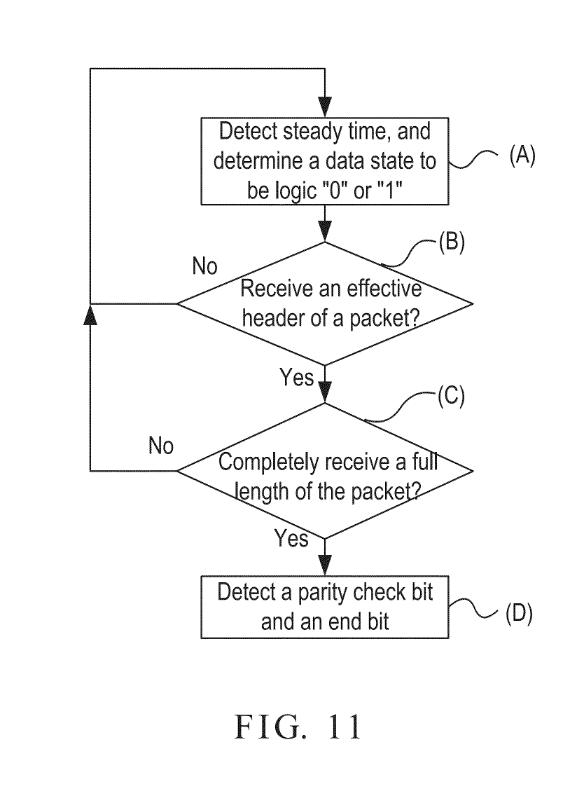

FIG. 11 is a flowchart of using the controller 520 to determine data according to an embodiment of the present invention. As shown in FIG. 11, in step (A), the controller 520 detects a steady time. As shown in FIGS. 8 and 11, the controller 520 is based on the number of touch points to determine the state S, Sa, or Sb. When one state S is detected and followed by a state Sa, the controller 520 determines the data state to be logic “1”. When one state S is detected and followed by a data state Sb, the controller 520 determines the data state to be logic “0”. Accordingly, the controller 520 can obtain data with a plurality of successive logic “1” or “0”.

In step (B), the controller 520 determines whether a received data is an effective header of a packet. The packet includes a header, data bits, a check bit, and an end bit, wherein the header contains nine bits with logic “1” each, the data bits contain eight bits, the check bit is an even parity check bit, and the end bit contains one bit with logic “0”. When the controller 520 determines that a received data is an effective header of a packet, step (C) is executed; otherwise step (A) is executed.

In step (C), the controller 520 determines whether a full length of the packet is completely received. When the full length of the packet is completely received, step (D) is executed to detect the check bit and the end bit; otherwise step (A) is executed. As a result, the invention can use the touch panel 510 to successfully carry out a data transfer.

The flowchart of FIG. 11 can be used in FIGS. 9 and 10 to determine data. In addition, although there are only states Sa and Sb in FIG. 5, the invention can be used with an asynchronous transfer technology to transfer data between the switch control unit 540 and the controller 520, which can be easily implemented by those skilled in prior art. Thus, a detailed description is deemed unnecessary.

As cited, the touch panel in the prior art is employed to produce one or more touch points. The invention makes use of the switch control unit 540 to configure every two of the conductive contacts 530 to be electrically connected or disconnected. Furthermore, the touch panel 510 can detect different numbers of touch points corresponding to the conductive contacts 530, so that the switch control unit 540 can transfer data to the controller 520. Namely, the invention can use the touch panel 510 as a communication medium to allow a handheld device without a USB, SD, and/or Bluetooth to transfer data with the peripherals.

In addition, the switch control unit 540 can be a microcontroller with GPIO pins, such as a typical 8051 microcontroller, thereby greatly reducing the hardware requirement and cost for data transfer.

Although the present invention has been explained in relation to its preferred embodiment, it is to be understood that many other possible modifications and variations can be made without departing from the spirit and scope of the invention as hereinafter claimed.

What is claimed is:

1. A touch-control communication system, comprising:
a touch panel, having a surface for detecting a plurality of touch points;
a controller, connected to the touch panel, for receiving data corresponding to the plurality of touch points detected on the touch panel;
a plurality of conductive contacts, placed on the surface of touch panel; and
a switch control unit, electrically connected to the plurality of conductive contacts,
wherein the switch control unit performs a switch operation to configure every two of the plurality of conductive contacts to be electrically connected or disconnected, for indicating a plurality of data states, thereby sending the plurality of data states to the controller.

2. The touch-control communication system as claimed in claim 1, wherein the plurality of conductive contacts include two conductive contacts which are configured to be electrically disconnected by the switch control unit such that the touch panel detects no touch point to indicate a first data state and which are configured to be electrically connected by the switch control unit such that the touch panel detects two touch points to indicate a second data state.

3. The touch-control communication system as claimed in claim 2, wherein the switch control unit is a micro control unit (MCU) with two general purpose input/output (GPIO) pins respectively connected to the two conductive contacts, such that the switch control unit is conducted when said two GPIO pins output a low potential so as to configure said two conductive contacts to be electrically connected and, otherwise, the switch control unit is not conducted so as to configure said two conductive contacts to be electrically disconnected.

4. The touch-control communication system as claimed in claim 3, wherein the controller determines a data state to be logic 0 when the first data state lasts a duration over triple of a detection time on the touch panel, and determines the data state to be logic 1 when the second data state lasts the duration over triple of the detection time on the touch panel.

5. The touch-control communication system as claimed in claim 1, wherein the plurality of conductive contacts include three conductive contacts, such that when the switch control unit configures every two of the three conductive contacts to be electrically disconnected, the touch panel detects no touch point to indicate a start state, and when the switch control unit configures only two of the three conductive contacts to be electrically connected, the touch panel detects two touch points to indicate a first data state, otherwise when the switch control unit configures every two of the three conductive contacts to be electrically connected, the touch panel detects three touch points to indicate a second data state.

6. The touch-control communication system as claimed in claim 5, wherein the switch control unit is a micro control unit (MCU) with three general purpose input/output (GPIO) pins respectively connected to the three conductive contacts, such that when the three GPIO pins are floating, every two of the three conductive contacts are electrically disconnected and the touch panel detects no touch point; when only two of the three GPIO pins output a low potential, corresponding two of the three conductive contacts are electrically connected and the touch panel detects two touch points, otherwise, when the three GPIO pins output the low potential, every two of the three conductive contacts are electrically connected and the touch panel detects three touch points.

7. The touch-control communication system as claimed in claim 6, wherein the controller determines that the data state is logic 1 when the start state and the second data state are detected and the data state is logic 0 when the start state and the first data state are detected.

8. The touch-control communication system as claimed in claim 5, wherein the three conductive contacts form a triangle on the surface of the touch panel.

9. The touch-control communication system as claimed in claim 7, further comprising a photosensor connected to an input pin of the switch control unit and placed in the triangle on the surface of the touch panel.

10. The touch-control communication system as claimed in claim 9, wherein the controller is based on brightness displayed on the surface of the touch panel corresponding to the photosensor for transferring data to the switch control unit.

11. The touch-control communication system as claimed in claim 1, wherein the plurality of conductive contacts include a first conductive contact, a second conductive contact, and a third conductive contact which are placed in a form of triangle on the surface of touch panel, such that when the switch control unit configures every two of the first, the second, and the third conductive contacts to be electrically disconnected, the touch panel detects no touch point for indicating a first data state; when the switch control unit configures the first conductive contact and the third conductive contact to be electrically connected, the touch panel detects two touch points respectively corresponding to positions of the first and the third conductive contacts for indicating a second data state; when the switch control unit configures the first conductive contact and the second conductive contact to be electrically connected, the touch panel detects two touch points respectively corresponding to positions of the first and second conductive contacts for indicating a third data state; and when the switch control unit configures the second conductive contact and the third conductive contact to be electrically connected, the touch panel detects two touch points respectively corresponding to positions of the second and the third conductive contacts for indicating a fourth data state.

12. The touch-control communication system as claimed in claim 11, wherein the controller determines a data state to be logic 00 when the touch panel detects the first data state, determines the data state to be logic 01 when the touch panel detects the second data state, determines the data state to be logic 10 when the touch panel detects the third data state, and determines the data state to be logic 11 when the touch panel detects the fourth data state.

13. The touch-control communication system as claimed in claim 1, wherein the plurality of conductive contacts include a first conductive contact, a second conductive contact, a third conductive contact, and a fourth conductive contact which are placed in a form of diamond on the surface of touch panel, where the first and the second conductive contacts are two opposite vertices of the diamond, and the first and the fourth conductive contacts are two adjacent vertices of the diamond, such that when the switch control unit configures the first conductive contact and the fourth conductive contact to be electrically connected, the touch panel detects two touch points respectively corresponding to positions of the first and the fourth conductive contacts for indicating a first data state; when the switch control unit configures the first conductive contact and the second conductive contact to be electrically connected, the touch panel detects two touch points respectively corresponding to positions of the first and second conductive contacts for indicating a second data state; when the switch control unit configures the first and fourth conductive contacts to be electrically connected and the first and second conductive contacts to be electrically connected, the touch panel detects three touch points respectively corresponding to positions of the first, the second, and the fourth conductive contacts for indicating a third data state; and when the switch control unit configures the first and fourth conductive contacts to be electrically connected, the first and second conductive contacts to be electrically connected, and the first and third conductive contacts to be electrically connected, the touch panel detects four touch points respectively corresponding to positions of the first, the second, the third, and the fourth conductive contacts for indicating a fourth data state.

14. The touch-control communication system as claimed in claim 13, wherein the controller determines a data state to be logic 00 when the touch panel detects the first data state, determines the data state to be logic 01 when the touch panel detects the second data state, determines the data state to be logic 10 when the touch panel detects the third data state, and determines the data state to be logic 11 when the touch panel detects the fourth data state.
